(19) United States
(12) Patent Application Publication
(10) Pub. No.: US 2018/0297568 A1
(43) Pub. Date: Oct. 18, 2018

(54) Electronic Brake Pressure Control System

(71) Applicant: Robert Bosch GmbH, Stuttgart (DE)

(72) Inventor: Michael Stemmler, Heilbronn (DE)

(21) Appl. No.: 15/762,511

(22) PCT Filed: Sep. 21, 2016
(86) PCT No.: PCT/EP2016/072361

§ 371 Date: Mar. 22, 2018

(30) Foreign Application Priority Data
Oct. 19, 2015 (DE) 10 2015 220 286.0

(51) Int. Cl. B60T 8/176; B60T 8/34; B60T 8/1755

(52) U.S. Cl. CPC B60T 8/176; B60T 8/34; B60T 8/1706; B60T 2270/30; B60T 2270/10; B60T 8/1755

(57) ABSTRACT

An electronic brake pressure control system for a vehicle includes an anti-lock brake device and a vehicle movement dynamics control device. The latter includes dynamics control electronics which are attached to the vehicle separately from the anti-lock brake device and are connected to a brake pressure control unit of the anti-lock brake device via a line connection. The dynamics control electronics are attached to a pressure medium assembly of the brake pressure control system and form, with the pressure medium assembly, a structural unit which is pre-assembled and secured to the vehicle. The dynamics control electronics are effectively isolated from little-side interference vibrations. The brake pressure control system, with or without vehicle movement dynamics control, is made available commercially in parallel and in a cost-effective way despite respective small individual production numbers.

The invention concerns an electronic brake pressure control system according to the features of the preamble of claim 1.

### PRIOR ART

Motorized single-track vehicles, such as motor cycles or scooters for example, but also small motor vehicles such as quads or three-wheel vehicles are now increasingly equipped with electronic brake pressure control systems in order to maintain the steerability of such vehicles even under extreme deceleration conditions. Said systems prevent locking of the vehicle wheels during a braking process by adjusting the brake pressure in the wheel brakes to the slip conditions prevailing on the associated wheels. For this purpose, a pressure medium assembly is provided that comprises a housing block populated by electronically actuated pressure medium control components and an electronic brake pressure control unit. The brake pressure control unit analyzes data, for example from wheel revolution rate sensors and from brake pressure sensors, and determines from the measurement values the demand-based actuation of the pressure medium control components or carries out said actuation as required.

In an expansion stage, such brake pressure control systems can be expanded by a vehicle dynamics control device. Said vehicle dynamics control device stabilizes the vehicle during critical driving states automatically, i.e. without the involvement of the driver. It is equipped with dynamic control electronics for this, which detect vehicle dynamic parameters of the vehicle, analyzes said parameters and passes said parameters to the electronic brake pressure control unit for the purpose of brake pressure build-up or brake pressure adjustment.

In the aforementioned vehicle category, the dynamic control electronics form a unit that is independent of the pressure medium assembly and that is mainly spatially separate from the pressure medium assembly on the respective vehicle. The reason for this is that the dynamic control electronics are populated inter alia with acceleration sensors, the proper operation of which can be adversely affected by interfering vehicle vibrations, such as can be produced for example by the engine of the vehicle. Placing the dynamic control electronics on the vehicle is therefore carried out so that the electronics are decoupled very well from engine vibrations, which however is only possible with said vehicles to a limited extent because of the design, or requires a relatively complex search for a suitable location on the vehicle. The brake pressure control unit and the dynamic control electronics communicate with each other in known systems via an externally implemented line connection.

With conventional passenger vehicles, it is by contrast usual to integrate the dynamic control electronics of the vehicle dynamics control within the control electronics of the brake pressure control unit. Because of the small number of items, said measure cannot be implemented in small motor vehicles or motor cycles for cost reasons, or would necessitate different versions of control units, in each case in even smaller production volumes. For small vehicles, vehicle dynamics control counts as optional equipment, whereas it is mainly standard equipment in passenger vehicles, and accordingly can be manufactured in significantly greater numbers and at correspondingly lower cost.

Against this background, it is the object of the invention to propose an electronic brake pressure control system that optionally provides an additional provision of a vehicle dynamics control device, but without disadvantages in respect of assembly costs on the vehicle in the case of an existing vehicle dynamics control device or in respect of functional limitations because of interfering vibrations acting on the vehicle side.

### Advantages of the Invention

The invention according to the features of claim 1 has the advantage that vehicles equipped with electronic brake pressure control systems, in particular single-track vehicles or motorized small motor vehicles, can be optionally and inexpensively expanded by a vehicle dynamics control device without as a result requiring of the manufacturer of the vehicle extra costs relating to the assembly and/or placement of dynamic control electronics that are necessary for this purpose. Brake pressure-controlled vehicles with or without vehicle dynamics control ultimately rely on the same basic components and, despite smaller individual production volumes, can therefore be inexpensively offered to the market in parallel with each other. The fastening of the components of the pressure medium assembly and/or dynamic control electronics to the vehicle is carried out independently of the scope of equipment and yet guarantees vibrational decoupling of the vehicle dynamics control, which is particularly sensitive thereto.

According to the invention, dynamic control electronics of a vehicle dynamics control are attached to the pressure medium assembly for this, and together with the housing block and the electronic brake pressure control unit form the pressure medium assembly of a unit that can be preassembled by the manufacturer of the assembly and fixed to the vehicle.

With such a unit, the type of fastening of the dynamic control electronics is defined by the manufacturer of the assembly and is optimized regarding the decoupling of possible vehicle-side interfering vibrations. Since the pressure medium assembly for brake pressure control for its part is already attached to the vehicle by vibration-damping measures and has a significantly greater mass compared to the dynamic control electronics of the vehicle dynamics control device, the transmission of vehicle-side interfering vibrations via the pressure medium assembly to the dynamic control electronics is effectively attenuated. The dynamic control electronics are in other words decoupled such that interfering vibrations have no negative effect on the function or the service life of the electronic vehicle dynamics control. The long necessary complex search for a suitable installation point for the dynamic control electronics of a vehicle dynamics control arrangement on the vehicle is likewise no longer required without replacement, such as any additional mountings for vibration-damping fastening of the dynamic control electronics to the vehicle. In addition, an arrangement according to the invention of the dynamic control electronics on the housing block and/or on the control unit of the anti-lock device enables very short line connections between the dynamic control electronics and the electronic control unit. This reduces the line connection costs, lowers the assembly costs of cable installation and reduces the risk of damage under everyday conditions. Regardless of this, the invention enables a parallel offering of brake pressure control systems to the market, which are optionally equipped with or without a vehicle dynamics control device and can be attached to the vehicle without extra cost.

Further advantages or advantageous developments of the invention arise from the subordinate claims or from the following description.

### DRAWING

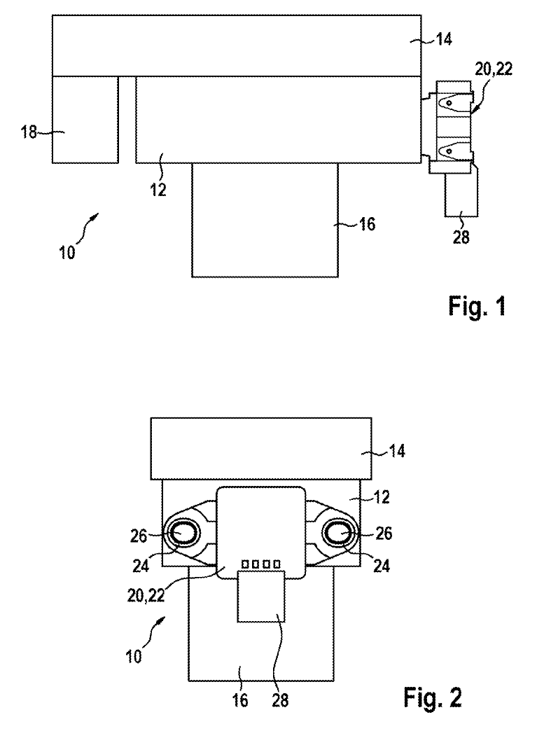

Exemplary embodiments of the invention are represented in the drawing and are described in detail in the following description. During this, the mutually corresponding components or assemblies of the respective FIGS. 1 through 6 are provided with consistent reference numbers.

In each case, a pressure medium assembly of an electronic brake pressure control system with a housing block, an electronic brake pressure control unit and dynamic control electronics are represented in the figures, wherein:

according to FIGS. 1 and 2, said dynamic control electronics are directly attached to the housing block of the pressure medium assembly;

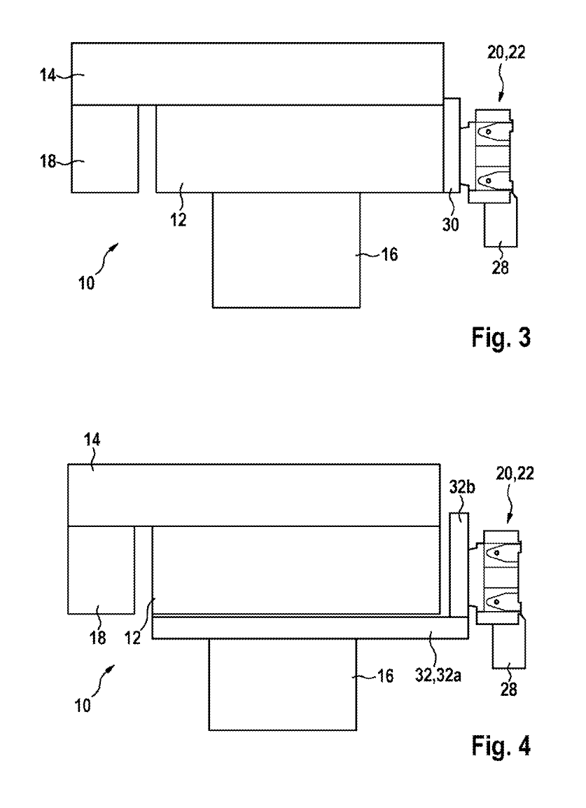

according to FIG. 3, the dynamic control electronics are indirectly attached to the housing block of the pressure medium assembly;

according to FIG. 4, the dynamic control electronics are attached to a leg of a bracket that is attached to the housing block;

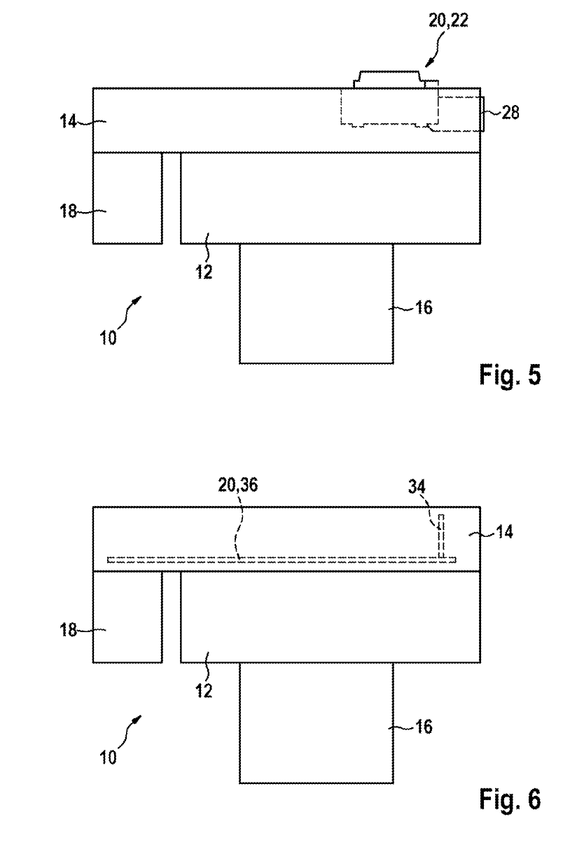

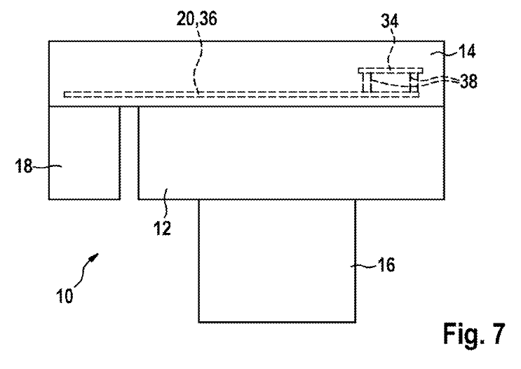

according to FIG. 5, the dynamic control electronics are attached to the exterior of the brake pressure control unit of the pressure medium assembly and according to FIGS. 6 and 7, the dynamic control electronics are mounted within the brake pressure control unit.

### DESCRIPTION OF THE EXEMPLARY EMBODIMENTS

FIGS. 1 and 2 show in a schematic, simplified representation a pressure medium assembly 10 of an electronic brake pressure control system, consisting of a housing block 12, an electronic brake pressure control unit 14 and an electric motor 16, each represented in a front view and a side view. The housing block 12 is of a cuboid shape and comprises a first outer surface, to which the brake pressure control unit 14 is attached, and a second outer surface opposite the first outer surface, to which the electric motor 16 is attached. The brake pressure control unit 14 protrudes laterally relative to a first lateral surface of the housing block 12 and is provided on said protruding region with an equipment plug 18. By means of the equipment plug 18, the pressure medium assembly 10 can for example be connected to a voltage supply and to signal lines, via which the brake pressure control unit 14 detects brake pressure information or wheel revolution rate information for example and processes said information further. From the sensor data, the brake pressure control unit 14 determines actuation signals for operating electronically controlled pressure medium control components, such as for example solenoid valves or pumps.

The latter are not visibly disposed on the housing block 12 and control the brake pressure in the wheel brakes, which are connected to the housing block 12 via pressure medium-carrying lines that are not represented. Control of the brake pressure is carried out so as to avoid locking of the wheels of the vehicle associated with the wheel brakes. For brake pressure control, the housing block 12 is populated with pumps that are operated by the electric motor 16 as required. For this purpose, the electric motor 16 is electrically connected to the brake pressure control unit 14.

The pressure medium assembly 10 is moreover equipped with dynamic control electronics 20 of a vehicle dynamics control arrangement. Said dynamic control electronics 20 are directly attached to the housing block 12 of the pressure medium assembly 10 according to FIGS. 1 and 2 and comprise an electronic housing 22 that is closed relative to the surroundings. Attachment lugs 24 with insertion openings 26 formed thereon for fastening means, for example screws, are formed on the electronic housing 22, so that the electronic housing 22 can be conventionally fixed to the housing block 12.

The electronic housing 22 of the dynamic control electronics 20 comprises a dedicated equipment plug 28 and as a result can be connected to a voltage supply independently of the brake pressure control unit 14. Within the electronic housing 22, sensor elements that are not visible are disposed on at least one circuit board and detect parameters representing the driving state of the vehicle. Such sensor information can for example be the inclination, the acceleration of the vehicle or the turn rate of the vehicle for a single-track vehicle, each measured in the different spatial axes. The dynamic control electronics 20 analyze said sensor information electronically and determine actuation signals for the brake pressure control system, by means of which the driving state of the vehicle can be stabilized as required. Via an externally implemented line connection (not represented) from the dynamic control electronics 20 to the brake pressure control unit 14, said actuation signals are passed to the brake pressure control unit 14 and taken into account during the adjustment of the brake pressure.

According to the exemplary embodiment according to FIG. 1, the dynamic control electronics 20 are attached directly to the housing block 12 of the pressure medium assembly 10. Said fastening is represented relatively simply using conventional fastening means and has the advantage that temperature changes in the surroundings have no significant effect on the vibration behavior of the pressure medium assembly 10 and the dynamic control electronics 20 installed thereon. Since the pressure medium assembly 10 for its part is already fixed to a vehicle in a vibrationally decoupled manner relative to an engine of the vehicle, interference-free operation, i.e. reliable detection or analysis of the vehicle dynamic parameters by the dynamic control electronics, 20 is guaranteed.

Should the vibration pulses occurring on the dynamic control electronics 20 under operating conditions nevertheless be impermissibly large, then the alternative attachment methods represented in the FIG. 3 are selected.

In this case, an additional damping element 30 is provided between the dynamic control electronics 20 and the housing block 12 of the pressure medium assembly 10. As the damping element 30, for example, a plate-shaped elastomeric part can be provided, the external dimensions of which are matched to the contact surface of the dynamic control device 20 on the housing block 12. The damping properties of the elastomeric part can be specified application-specifically by the targeted selection of the elastomer material, by dimensioning, in particular the slice thickness of the damping element 30, and/or by structural measures such as for example apertures or stiffenings formed on the damping element 30.

FIG. 4 shows a further alternative to a vibration-decoupled fastening of the dynamic control electronics 20 to the housing block 12 of the pressure medium assembly 10. With said exemplary embodiment, an angled bracket 32 is provided that is fixed by a first leg 32a to the outside of the housing block 12 with the electric motor 16 and that comprises a second leg 32b angled at right angles to the first leg 32a on a laterally protruding section of the housing block 12, forming a flange for fastening the electronic housing 22 of the dynamic control electronics 20. There is an air gap between the second leg 32b of the angled bracket 32 and the facing lateral surface of the housing block 12, whereby the transition from the first leg to the second leg of the angled bracket acts as a linkage that vibrationally decouples the second leg 32b relative to the first leg 32a. Consequently, any vibrations of the pressure medium assembly 10 are transferred in an attenuated form, if needed, to the flange or to the dynamic control electronics 20 that are attached to the flange. Owing to the structural design of the transition from the first leg 32a to the second leg 32b of the angled bracket 32, and to the dimensions and/or the material selected for the angled bracket 32, the damping effect thereof can be specified application-specifically. The angled bracket 32 acts additionally to the already provided decoupling of the pressure medium assembly 10 relative to the body of the vehicle, and additionally brings about decoupling of the dynamic control electronics 20 relative to the pressure medium assembly 10.

FIG. 5 shows a version, with which the dynamic control electronics 20 are no longer attached to the housing block 12 of the pressure medium assembly 10, but rather to the housing of the brake pressure control unit 14. Said housing is by way of example provided on an external side remote from the electric motor with a molding in which the dynamic control electronics 20 with the electronic housing 22 thereof and the equipment plug 28 embodied thereon are at least partly embedded so that the equipment plug 28 is still accessible for plugging in a matching plug. The fixing of the dynamic control electronics 20 to the housing of the brake pressure control unit 14 is carried out in a conventional way, for example by at least one screw connection, by fitting said brake pressure control unit 14 with for example stud bolts, into which the fixing screws of the dynamic control electronics 20 can be screwed. An advantage of said version is that no separate mounting bracket is necessary for fastening the dynamic control electronics 20 and that the dynamic control electronics 20 for their part are attached to the pressure medium assembly in a space-saving manner and so as to be protected against external damage.

With the embodiment versions represented in FIGS. 6 and 7, the dynamic control electronics 20 are implemented without a dedicated electronic housing, and therefore consist of a circuit board 34, which is populated by the sensors described above and the electronic components for the analysis of the detected sensor data. Said circuit board 34 is mounted within the housing of the brake pressure control unit 14 and is attached to a second circuit board associated with the brake pressure control unit 14. According to the exemplary embodiments, the circuit board 34 of the dynamic control electronics 20 can be disposed at right angles or upright or parallel or lying down relative to the circuit board 36 of the brake pressure control unit 14. In the last-named case, the circuit board 36 of the brake pressure control unit 14 is provided with contact pins 38, onto which the dynamic control electronics 20 are plugged and electrically connected to the brake pressure control unit 14. With both exemplary embodiments, therefore at the same time as the fastening of the circuit board 34 of the dynamic control electronics 20 to the circuit board 36 of the brake pressure control unit 14, an electrical connection is made between the circuit boards or between the control units, so that an external line connection is saved with said exemplary embodiments.

Of course, changes or extensions relative to the described exemplary embodiments are conceivable without deviating from the basic idea of the invention.

1. An electronic brake pressure control system of a brake pressure control system, comprising:
an anti-lock control device configured to adjust a brake pressure of at least one wheel brake of a vehicle to slip conditions of a wheel associated with the at least one wheel brake;
a pressure medium assembly of a housing block populated with electronically operated pressure medium control components;
an electronic brake pressure control unit configured to carry out actuation of the pressure medium control components as required; and
a vehicle dynamics control device configured to stabilize a driving state of the vehicle, the vehicle dynamics control device comprising dynamic control electronics configured to detect vehicle dynamic parameters of the vehicle, to analyze the parameters to form control signals, and to feed the control signals to the electronic brake pressure control unit,
wherein the dynamic control electronics are attached to the pressure medium assembly and form a premountable externally fixable unit together with the pressure medium assembly.

2. The electronic brake pressure control system as claimed in claim 1, wherein the dynamic control electronics are disposed within an electronic housing that is attached to an external side of the pressure medium assembly.

3. The electronic brake pressure control system as claimed in claim 2, further comprising:
a damping element disposed between the electronic housing of the dynamic control electronics and the housing block of the pressure medium assembly.

4. The electronic brake pressure control system as claimed in claim 2, wherein the dynamic control electronics with the electronic housing thereof are fixed to a bracket that is attached to the pressure medium assembly.

5. The electronic brake pressure control system as claimed in claim 1, wherein the dynamic control electronics are disposed within an electronic housing, which is attached to an external side of the brake pressure control unit of the pressure medium assembly.

6. The electronic brake pressure control system as claimed in claim 1, wherein the dynamic control electronics comprise a circuit board populated with electronic components and sensors, which is disposed within the electronic brake pressure control unit and is attached to a second circuit board that is associated with the brake pressure control unit.

7. The electronic brake pressure control system as claimed in claim 6, wherein the circuit boards of the dynamic control electronics and the brake pressure control unit are electrically connected to each other.

8. The electronic brake pressure control system as claimed in claim 1, further comprising:
a plurality of fastening members provided in pairs on the pressure medium assembly and on the dynamic control electronics,
wherein the fastening members are configured to mechanically fasten the dynamic control electronics to the pressure medium assembly.
